(19) United States
(12) Patent Application Publication
(10) Pub. No.: US 2008/0248176 A1
(43) Pub. Date: Oct. 9, 2008

(54) SUGAR FREE AND REDUCED SUGAR CHOCOLATE AND METHODS OF MANUFACTURE

(76) Inventor: Robert Brown, San Jose (CR)

Correspondence Address: MEREDITH & KEYHANI, PLLC, 330 MADISON AVE., 6TH FLOOR, NEW YORK, NY, 10017, US

(21) Appl. No.: 11/845,049

(22) Filed: Aug. 25, 2007

Related U.S. Application Data
(63) Continuation-in-part of application No. 11/696,946, filed on Apr. 5, 2007.

(51) Int. Cl. A23G 1/40

(52) U.S. Cl. 426/534; 426/631; 426/660

(57) ABSTRACT

A method of producing a sugar free chocolate composition comprising the steps of: reducing the moisture content in a predetermined amount of agave syrup to produce a reduced moisture agave syrup; thoroughly mixing at least the following ingredients: 1 to 95% by weight reduced moisture agave syrup; and 3 to 60% by weight of at least one edible fat so as to produce a mixture; adding an additional emulsifier to the mixture to provide an emulsion; providing cacao liquor that has been pretreated to remove noxious odors and to reduce all particle sizes to less than 20 microns to provide a pretreated cacao liquor; adding pretreated cacao liquor to the emulsion to provide a chocolate mixture; tempering the chocolate mixture to enable the chocolate mixture to be formed product; and forming a chocolate product.

This application is a continuation in part of application Ser. No. 11/696,946 as filed Apr. 5, 2007 and entitled “Sugar Free and Reduced Sugar Chocolate and Methods of Manufacture”.

The present invention relates generally to sugar free chocolate and methods of manufacturing sugar free chocolates utilizing natural and/or organic ingredients.

The health benefits of Cacao are well known. Cacao is rich in antioxidants, has been associated with decreased diabetes and blood pressure, is rich in B1, B2 and D vitamins, magnesium and iron, is associated with improved vasodilatation, helping increase stamina during exercise, is cholesterol free and may even block oxidation of LDL cholesterol. Chocolate is associated with euphoria and reduced depression due to phenylthylamine. Serotonin, a well-studied neurotransmitter, is thought to instill calm and relaxed feelings. Chocolate is associated with increased serotonin levels, a factor that is believed to explain chocolate cravings.

While Cacao has many health benefits, sugar is generally added to make the taste palatable and has many health drawbacks. Sugar may cause hypertension, added calories, diabetes, tooth decay and weight gain. There are over one (100) well known and documented detrimental health effects associated with sugar. High-sugar foods also displace whole foods and contribute to nutritional deficiencies adding empty calories that few Americans need. High sugar foods contribute to obesity now considered by some in the medical profession as a disease.

One sugar substitute is Agave. Agave has health-promoting components that have many positive effects including having a direct stimulatory effect on the immune system, increase the effectiveness of both injected and oral vaccines, decrease blood lipids, lower cancer risks, and lower blood glucose response, inhibits dental aries and platelet aggregation. However, the problem with the addition of Agave is that it is made up of approximately twenty five percent (25%) water. Chocolate production and processing methods avoid contact with water since small amounts of added water causes severe rheological changes in the product, usually accompanied by lumping and/or granulation leading to a coarse unacceptable eating texture (Minifie, B. W. Chocolate, Cocoa and Confectionary—Science and Technology, 3 edition, Chapman & Hall (1989)). Larger amounts of water results in a fudge like product that has a short shelf life and lacks the “snap, luster and taste” of chocolate products.

Because of the difficulty of adding sugar substitutes that contain water, Chocolatiers have generally utilized chemically based sugar substitutes, such as xylitol, sorbitol, mannitol, lactitol, malitol, isomalt, polydextrose and other chemically created sugar substitutes. However, such substitutes could never be natural, organic and/or sugar free and such products are increasingly popular.

Accordingly, the present invention has solved the long felt need of the chocolate industry by utilizing Agave as a sweetener to provide a natural and/or organic, sugar free chocolate that tastes goods, remains stable at room temperature and has the desired snap, luster and taste that consumers demand.

### SUMMARY OF THE INVENTION

The present invention relates generally to sugar free chocolates utilizing natural and/or organic ingredients and their method of manufacture.

According to one embodiment, a method of producing a sugar free chocolate composition is disclosed comprising the steps of: reducing the moisture content in a predetermined amount of agave syrup to produce a reduced moisture agave syrup; thoroughly mixing at least the following ingredients: 1 to 95% by weight said reduced moisture agave syrup; and 3 to 60% by weight of at least one edible fat so as to produce a mixture; adding an additional emulsifier to the mixture to provide an emulsion; providing cacao liquor that has been pretreated to remove noxious odors and to reduce all particle sizes to less than 20 microns to provide a pretreated cacao liquor; adding pretreated cacao liquor to the emulsion to provide a chocolate mixture; tempering the chocolate mixture to enable the chocolate mixture to be formed product; and forming the chocolate product. The resulting chocolate may be organic and/or natural depending on the ingredients used.

According to another embodiment, a method of producing a sugar free chocolate composition comprising the steps of: reducing the moisture content in a predetermined amount of agave syrup under pressure, heat and vacuum to produce a reduced moisture agave syrup; thoroughly mixing under pressure, heat and vacuum at least the following ingredients: 1 to 95% by weight said reduced moisture agave syrup; and 3 to 60% by weight of at least one edible fat; so as to produce a mixture; adding an additional emulsifier under pressure, heat and vacuum to said mixture to provide an emulsion; providing cacao liquor that has been pretreated to reduce all particle sizes to less than 20 microns to provide a pretreated cacao liquor; providing cacao liquor that has been pretreated to remove all noxious odors; refining said cacao liquor prior to provide a refined cacao liquor; adding said refined cacao liquor to said emulsion under pressure, heat and vacuum to provide a chocolate mixture; conching said chocolate mixture; tempering said chocolate mixture to provide a chocolate product; and forming said chocolate product.

These and other features, aspects and advantages of the present invention will become better understood with reference to the following description and claims.

### BRIEF DESCRIPTION OF THE DRAWINGS

FIG. 1 depicts the present invention; and

FIG. 2 depicts the present invention;

### DETAILED DESCRIPTION OF THE INVENTION

The following detailed description is of the best currently contemplated modes of carrying out the invention. The description is not to be taken in a limiting sense, but is made merely for the purpose of illustrating the general principles of the invention, since the scope of the invention is best defined by the appended claims.

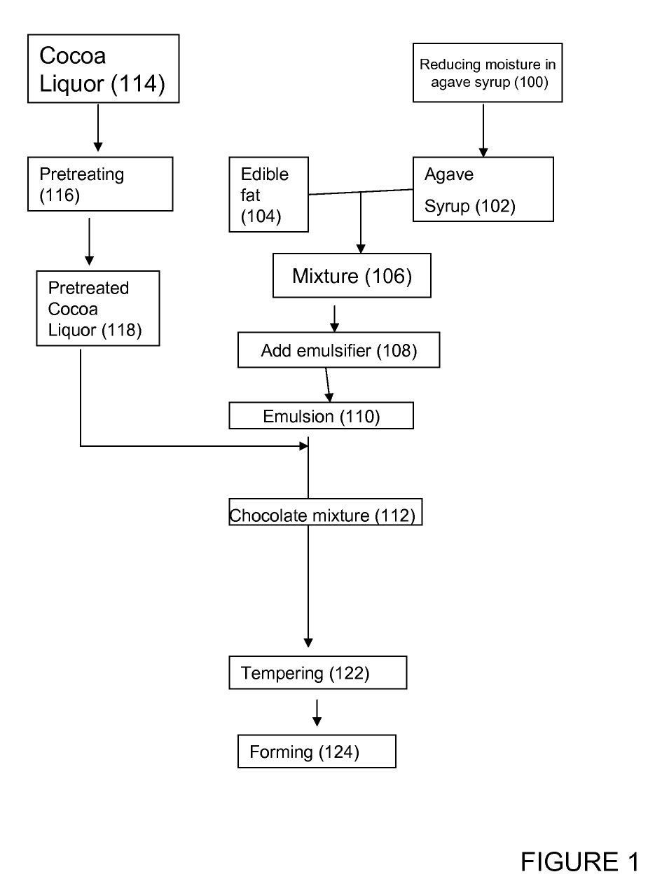

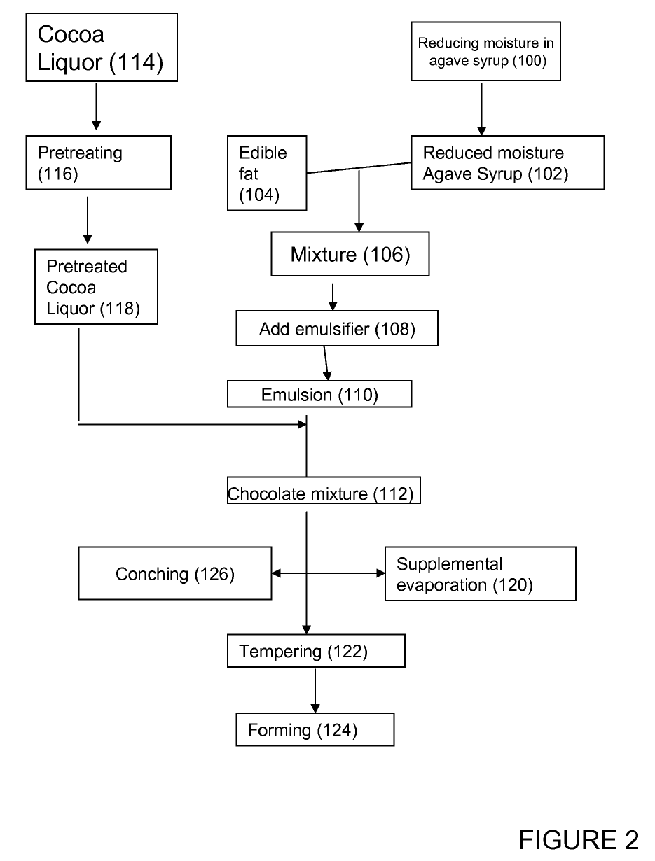

As depicted in FIGS. 1-2, the present invention provides sugar free natural chocolate and methods of manufacturing sugar free natural and/or organic chocolate. Agave syrup (also called agave nectar) is a sweetener mostly produced in Mexico, from several species of agave, including Agave tequilana (also called Blue Agave or Tequila Agave), and the Salmiana, Green, Grey, Thorny, and Rainbow varieties. Agave syrup is sweeter than honey, though less viscous. The main carbohydrate is a complex form of fructose. Agave syrup consists primarily of fructose and glucose. One source gives 92% fructose and 8% glucose. One of the benefits of the Agave syrup is that it has a very low Glycemic Index of 19 to 27. The complex composition of the molecules of Agave cause the fructose and glucose to pass through the body without the fructose or sucrose digested into the blood stream rapidly as with sugars. Digestion of the Agave and Cacao is slow and occurs in the large intestine releasing the fructose and sucrose over a long period of time. Thus weight gain, highs and lows of sugar ingestion, and all the detrimental affects of sugar are avoided.

As shown in FIG. 1, the method may comprise the steps of (100) reducing the moisture content in a predetermined amount of agave syrup to produce a reduced moisture agave syrup (102); thoroughly mixing at least the following ingredients: 1 to 95% by weight reduced moisture agave syrup (102); and 3 to 60% by weight of at least one edible fat (104) so as to produce a mixture (106); adding an additional emulsifier (108) to the mixture to provide an emulsion (110); providing cacao liquor (114) that has been pretreated (116) to remove noxious odors and to reduce all particle sizes to less than 20 microns to provide a pretreated cacao liquor (118); adding pretreated cacao liquor (118) to the emulsion to provide a chocolate mixture (112); tempering (122) the chocolate mixture to enable the chocolate mixture to be formed product; and forming (124) the chocolate product. The resulting chocolate may be organic and/or natural depending on the ingredients used. During any of the steps there may be supplemental evaporation, or an additional step of evaporating water utilizing an additional water removal means. The additional water removal means may be vacuum, heating means, conch and a dehydration attachment. According to a preferred embodiment, the agave is placed in a chamber under pressure and heated while being mixed to reduce the moisture. The pressure may be between 1 bar and 1000 bar. During this process a vacuum may be attached to the chamber to assist in removing moisture. The cacao butter is mixed into the Agave Syrup with the pressure and heat and mixing continuing and the vacuum still functioning. An emulsifier may be added to provide an emulsion. An example of emulsifier may be lecithin. The cacao liquor which has been pretreated to reduce particle size to less than 20 microns and to remove noxious odors. A ball mill may be used to reduce particle size to less than 20 microns. Removal of the noxious odors may also be accomplish through many methods including in the ball mill itself. A conching machine may also be used. These are examples, but are not to be taken in a limiting sense as a number of different methods, as can be appreciated by those of skill in the art, may be utilized to reduce the particle size and remove noxious odors. The cacao liquor may then be added to the emulsion. The ratio of cacao liquor to emulsion may be 45% by weight emulsion to 55% by weight cacao liquor. There may be additional conching and/or supplemental evaporation at any step in the process without departing from the present invention. According to one preferred embodiment, a chocolate bar produced according to the present invention would be 250 Kg agave syrup, 90 Kg Cacao Butter, 5 Kg Lecithin, 330 Kg Cacao Liquor. The chocolate may be approximately 70% by weight cacao of which 15% by weight is cacao butter and 55% by weight is cacao liquor.

The additional water removal means may be vacuum, conch, a dehydration attachment, a heating means. A conching machine will, over time, result in decreased water content, due to the heat created by the movement of the mixture. However, the small amount of dehydration is not sufficient to provide a chocolate of the desired texture, shelf life, snap, luster and taste. As shown in FIG. 2, the present invention may require additional evaporation (120) to prevent the chocolate from turning fudge like, chunky and having an unpleasant texture. There may additionally be the step of conching (126). The step of tempering (108) allows the chocolate to be molded to form a bar, drop or any shape of a mold. The chocolate can be tempered for spraying in panning and other methods for covering diverse items. There may also be the step of adding a flavor enhancer. The flavor enhancer may be selected from the group consisting of milk powder, caramel, nougat, herbs, spices, fruit, nuts, sugar, sugar substitute and any combination thereof. The milk powder may be added prior initially, prior to mixing (100) or even during the step of forming (110) the chocolate product, as would be the case with coatings. Additional sugars and sugar substitutes may be added at any step in the invention, without departing from the present invention. It may, for example, be desirable to use agave syrup and sugar or agave syrup and a sugar substitute. In this way, the sugar levels may be adjusted according to the needs of the consumers. The steps, as disclosed, provide a chocolate that has a distinctive snap, luster, and taste after forming stays solid and hard at room temperature, does not bloom and has a shelf life of at least one year.

It should be understood that the foregoing relates to preferred embodiments of the invention and that modifications may be made without departing from the spirit and scope of the invention as set forth in the following claims.

I claim:

1. A method of producing a sugar free chocolate composition comprising the steps of:
reducing the moisture content in a predetermined amount of agave syrup to produce a reduced moisture agave syrup;
thoroughly mixing at least the following ingredients:
1 to 95% by weight said reduced moisture agave syrup; and
3 to 60% by weight of at least one edible fat;
so as to produce a mixture;
adding an additional emulsifier to said mixture to provide an emulsion;
providing cacao liquor that has been pretreated to remove noxious odors and to reduce all particle sizes to less than 20 microns to provide a pretreated cacao liquor;
adding said pretreated cacao liquor to said emulsion to provide a chocolate mixture;
tempering said chocolate mixture to enable the chocolate mixture to be formed product; and
forming said chocolate product.

2. A method as in claim 1, wherein said at least one edible fat is cacao butter.

3. A method as in claim 2, wherein said at least one edible fat is selected from (a) cocoa butter and (b) cocoa butter and at least one other edible fat.

4. A method as in claim 2, wherein said cacao butter is about 15% by weight, said Cacao Liquor is about 55% by weight and said Agave Syrup is about 25% by weight.

5. A method as in claim 1, further comprising the step of evaporating water utilizing an additional water removal means.

6. A method as in claim 1, wherein any of the steps are performed under pressure, wherein said pressure is between 1 bar and 1000 bar.

7. A method as in claim 1, wherein any of the steps are performed under vacuum conditions.

8. A method as in claim 5, wherein said additional water removal means is selected from the group consisting of a vacuum, heating means, conch and a dehydration attachment.

9. A method as in claim 1, further comprising the step of adding a flavor enhancer, wherein said flavor enhancer is selected from the group consisting of milk powder, sugar, sugar substitute, caramel, nougat, herbs, spices, fruit, nuts and any combination thereof.

10. A method as in claim 1, further comprising the step of:
refining said cacao liquor prior to said mixing step.

11. A method as in claim 1, further comprising the step of:
conching said mixture.

12. A method as in claim 1, wherein said step of providing cacao liquor that has been pretreated to reduce all particle sizes to less than 20 microns to provide a pretreated cacao liquor is accomplished by conching said cacao liquor.

13. A method of producing a sugar free chocolate composition comprising the steps of:
reducing the moisture content in a predetermined amount of agave syrup under pressure, heat and vacuum to produce a reduced moisture agave syrup;
thoroughly mixing under pressure, heat and vacuum at least the following ingredients:
1 to 95% by weight said reduced moisture agave syrup; and
3 to 60% by weight of at least one edible fat;
so as to produce a mixture;
adding an additional emulsifier under pressure, heat and vacuum to said mixture to provide an emulsion;
providing cacao liquor that has been pretreated to reduce all particle sizes to less than 20 microns to provide a pretreated cacao liquor;
providing cacao liquor that has been pretreated to remove all noxious odors;
refining said cacao liquor prior to provide a refined cacao liquor;
adding said refined cacao liquor to said emulsion under pressure, heat and vacuum to provide a chocolate mixture;
conching said chocolate mixture;
tempering said chocolate mixture to provide a chocolate product; and
forming said chocolate product.

14. A method as in claim 13, wherein said at least one edible fat is cacao butter.

15. A method as in claim 14, wherein said at least one edible fat is selected from (a) cocoa butter and (b) cocoa butter and at least one other edible fat.

16. A method as in claim 13, wherein said cacao butter is about 15% by weight, said Cacao Liquor is about 55% by weight and said Agave Syrup is about 25% by weight.

17. A method as in claim 13, further comprising the step of evaporating water utilizing an additional water removal means, wherein said additional water removal means is selected from the group consisting of a vacuum, heating means, conch and a dehydration attachment.

18. A method as in claim 1, further comprising the step of adding a flavor enhancer, wherein said flavor enhancer is selected from the group consisting of milk powder, sugar, sugar substitute, caramel, nougat, herbs, spices, fruit, nuts and any combination thereof.
